(19) United States
(12) Patent Application Publication
(10) Pub. No.: US 2020/0153679 A1
(43) Pub. Date: May 14, 2020

(54) METHOD FOR ENHANCING STATUS COMMUNICATIONS IN A SDN-BASED COMMUNICATION SYSTEM

(71) Applicants: Yinfeng Henry YU, Ottawa (CA); Aihua GUO, Herndon, VA (US)

(72) Inventors: Yinfeng Henry YU, Ottawa (CA); Aihua GUO, Herndon, VA (US)

(73) Assignee: HUAWEI TECHNOLOGIES CO., LTD., Shenzhen (CN)

(21) Appl. No.: 16/184,611

(22) Filed: Nov. 8, 2018

(51) Int. Cl. H04L 12/24

(52) U.S. Cl. CPC H04L 41/069; H04L 41/0631; H04L 41/0859

(57) ABSTRACT

The present disclosure discloses methods and architectures for providing improved status reporting communications between management plane and control plane operations in a software-defined networking (SDN) communication system. A user configuration request is received to establish a connection with a server and to implement a configuration change of a network element. An operational ID and a control plane job ID are assigned to the user configuration request. A correlation module correlates the assigned operational ID with the assigned control plane job ID. The control plane is requested to verify the implementation of the user configuration request based on the corresponding control plane operation. Upon receiving verification from the control plane that the user configuration request has been implemented, a record of the implemented user configuration request is written into an operational status datastore, the user configuration request has not been implemented, an error status message is returned and stored into the operational status datastore.

### TECHNICAL FIELD

The present disclosure relates generally to the field of software-defined networking (SDN), and in particular to enhancing communications between management plane and control plane operations within a SDN-based communication platform.

### BACKGROUND

Modern communication systems require the management and control of network elements. To this end, the SDN provides an interactive platform to facilitate the monitoring and configuration of network elements. The SDN platform provides for three basic configuration levels: control plane, data plane, and management plane. The control plane and management plane serve the data plane, which bears the network traffic. The management plane, which carries administrative traffic, is configured as a subset of the control plane. The control plane is the part of the network that carries signaling traffic and is responsible for routing. Functions of the control plane include system configuration and management.

Various protocols and models specify the operations between the control, management, and data planes. For example, Yet Another Next Generation (YANG) modeling language and RESTCONF (which is an Internet Engineering Task Force (IETF) draft that described how to map a YANG specification to a RESTful interface) protocol provide standards that describe how to map a YANG-based commands to a RESTful interface.

However, in some instances, these standards may not adequately correlate information between the management and control planes to effectively communicate operational status issues for network hardware element upgrades or configuration changes.

### SUMMARY

An object of the present disclosure is to provide methods and architectures of providing improved status reporting communications between management plane and control plane operations in a SDN communication system.

In accordance with this objective, an aspect of the present disclosure provides a method comprising receiving, at a server, a user configuration request to establish a connection with the server and to implement a configuration change of a network element, assigning an operational ID to the user configuration request; validating the user configuration request in accordance with a configuration datastore; assigning a control plane job ID to the user configuration request; correlating the assigned operational ID with the assigned control plane job ID; requesting the control plane to verify the implementation of the user configuration request based on the corresponding control plane operation; and upon receiving verification from the control plane that: the user configuration request has been implemented, writing into an operational status datastore a record of the implemented user configuration request, the user configuration request has not been implemented, returning an error status message and storing the error status message in the operational status datastore.

Generally stated, the present disclosure provides an architecture for providing improved reporting status communications between a management plane and control plane operations in a SDN communication system, comprising server configured to receive a user configuration request to establish a connection with the server and to implement a configuration change of a network element, the server further configured to validate the user configuration request; a network protocol datastore including an intended configuration datastore and an operational status datastore, configured to store user configuration and operational status; a control plane configured to verify the user configuration request; and a correlation module configured to provide a network interface to correlate the control plane operations with the management plane operations; wherein upon the control plane has implemented the user configuration request, the control plane writes into the operational status datastore a record of the implemented user configuration request, and upon the control plane has not implemented the user configuration request, the control plane returns an error status message to the correlation module, and the correlation module stores the error status message into the operational status datastore.

Implementations of the present disclosure each have at least one of the above-mentioned object and/or aspects, but do not necessarily have all of them. It should be understood that some aspects of the present disclosure that have resulted from attempting to attain the above-mentioned object may not satisfy this object and/or may satisfy other objects not specifically recited herein.

Additional and/or alternative features, aspects and advantages of implementations of the present disclosure will become apparent from the following description, the accompanying drawings and the appended claims.

### BRIEF DESCRIPTION OF THE DRAWINGS

Embodiments of the present disclosure will be described by way of example only, with reference to the accompanying drawings.

FIG. 1 is a schematic diagram of prior art method of establishing communication between a user and network hardware.

FIG. 2A is a schematic diagram of one possible implementation of the method in accordance with the present disclosure.

FIG. 2B is a schematic diagram of a mapping table of correlation module in accordance with the present disclosure.

FIG. 3 is a schematic diagram of another possible implementation of the method implemented in YANG model in accordance with the present disclosure.

FIG. 4 is a schematic diagram of a communication process between an external entity and a SDN controller in accordance with the prior art.

FIG. 5 is a schematic diagram of the Remote Procedure Call (RPC) mechanism that is used to establish the communication between a user and the control plane in accordance with the embodiment of the present disclosure.

FIG. 6 shows a schematic view of RESTCONF RPC mechanism implemented in the YANG model in accordance with the embodiment of the present disclosure.

Like numerals represent like features on the various drawings. It should also be noted that, unless otherwise explicitly specified herein, the drawings are not to scale.

### DETAILED DESCRIPTION

A detailed description of the present disclosure will be discussed with respect to the accompanying figures. The embodiments of the concepts disclosed herein are intended to be illustrative, as the scope of the present disclosure should not be limited to such.

### Conventional YANG-Based Commands for RESTCONF Operations

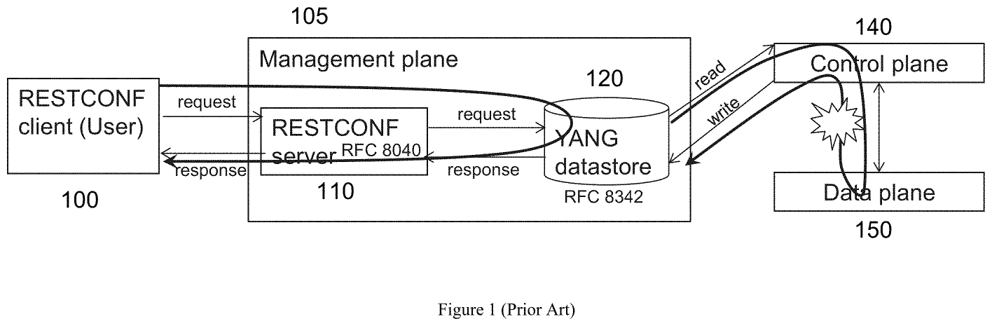

As illustrated by FIG. 1 (Prior Art), a typical RESTCONF user/client 100 may make a request, in accordance with YANG-based command syntax, to management plane 105. The request may include user configuration information to apply to the network communication hardware device. In this exemplary scenario, the user configuration information is directed to data required to modify the network hardware device from its initial default state into a desired operational state. As shown, the management plane 105 logically includes a RESTCONF server 110 and a YANG datastore 120 while control plane 140 is configured to read the data stored in datastore 120 and write data into datastore 120.

Control plane 140 is configured to control the functions and processes that determine which path to use, such as, for example, routing protocols, spanning tree, signaling, path computation, Label Distribution Protocol (LDP), etc.

Management plane 105 may comprise the functions necessary to control and monitor devices. Datastore 120 is a conceptual entity that stores and facilitates access to information. Datastore 120 may be implemented, for example, by employing files, databases, flash memory locations, or combinations thereof. Control plane 140 is configured to exchange data with data plane 150. Data plane 150 may refer to all the functions and processes that forward packets/frames from one interface to another. As shown in FIG. 1, the line with arrow on the left refers to a RESTCONF operational call flow. The RESTCONF operations may validate syntax and data schema of the user's request against the YANG model schema by RESTCONF server. A value is returned after the validation.

Although control plane 140 can read to and write from YANG datastore 120, the operations of control plane 140 are independent from the RESTCONF operations. Therefore, the returned value from YANG datastore 120 only reflects the status of the datastore operations rather than that of control plane 140. For example, if errors occur on the control plane operations, user 100 does not receive any error message from the control plane. The problem is that a reported successful RESTCONF operation does not confirm a successful subsequent control plane operation. As a result, when the subsequent control plane operation fails to successfully apply the user configuration information to a network hardware device, there is no adequate mechanism to inform the user of the failure.

Based on the deficiencies noted above, in order to enable users to query the status of the control plane operations and effectively receive useful feedback regarding the status of network elements in response to those operations, a correlation module that associates control plane operations with error reporting communications regarding with YANG-based operations is described herein. The proposed correlation module may be embodied as a software-based construct that is configured to correlate YANG operations in accordance with the management plane with and control plane counterparts.

In particular, the correlation module is configured with a YANG interface to comply with Network Configuration Protocol (NETCONF) and RESTCONF protocol communications. In this manner, status information based on the correlational relationship between the management plane and their control plane counterparts may be reported to the user via YANG module.

As discussed in detail below, the correlation module is configured to maintain an associative mapping between the YANG operations and control plane operations. The correlation module also provides the YANG interface, which, combined with the mapping, enables the user to access control plane status. As a result, not only is the user capable of viewing the status of the control plane operations, users are capable of retrying or cancelling the failed operations, based on the status information received, as well as providing users with an error reporting mechanism and the facility to provide users with manual intervention capabilities to correct any failed control plane operations.

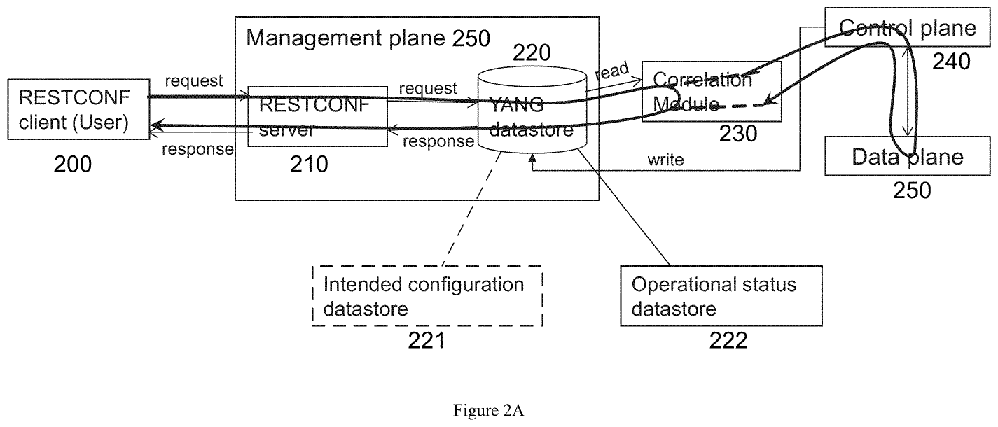

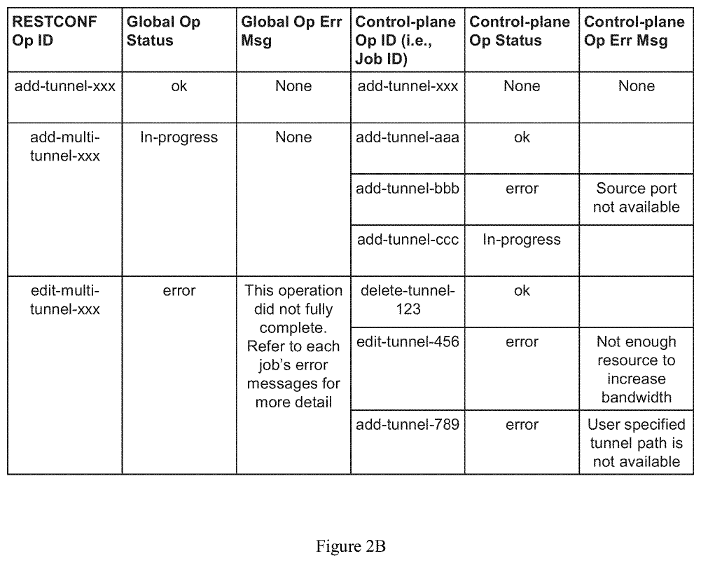

With this said, FIG. 2A illustrates a flow diagram of the process in accordance with an embodiment of the present disclosure. It will be appreciated that the RESTCONF protocol is only used as an example and the concepts and principles of described by the present disclosure are not limited to this protocol in any way. A person skilled in the art may use other protocols, such as NETCONF or gRPC, to implement the method. As well, JavaScript Object Notation (JSON) may be used to describe data format. However, other formats, such as Extensible Markup Language (XML) or Protocol Buffer, may also be used to implement the method.

As illustrated in FIG. 2A, when a RESTCONF client or user (referred to client or user below) 200 attempts to connect to the network, user 200 sends a request message to the network. For example, the user may send a “POST” request message defined by the RESTCONF protocol. The request message will be assigned an operation identification (ID) by correlation module 230.

Management plane 205 logically comprises a RESTCONF server 210 and a YANG datastore 220. Server 210 receives user 200 request message and interprets the request message in accordance with the YANG module. Server 210 then acquires the configuration parameter defined in YANG module. After referring to YANG datastore 220, which includes intended configuration datastore 221 and operational status datastore 222, server 210 confirms whether the user message is valid or not by comparing configuration parameters contained within the request message with that in intended configuration datastore 221.

Specifically, server 210 performs syntax checks of user request message. It validates whether input payload in the user configuration contained within the user request message contains valid JSON (or XML) syntax, such as, for example, if the input JSON string's brackets are balanced. This is the most basic validation performed by the RESTCONF server. Moreover, the server may do schematic check. It validates input JSON data against the schema of the YANG model. For example, it checks if the structure of the JSON data is consistent with the YANG model.

This check may also be performed by RESTCONF server which “knows” the YANG model schema. Intended configuration datastore 221 is a datastore that records the user configuration input by the user. Operational status datastore 222 stores the operational status of the control plane. Server 210 may store the configuration parameter to intended configuration datastore 221.

FIG. 2B depicts a mapping table of correlation module 230 in accordance with an embodiment of the present disclosure. Correlation module 230 maintains a mapping table which indicates the correlation between the management plane and the control plane. It is noted that the following example is for illustrative purposes only and the disclosed concepts are not limited to such.

The most left column of FIG. 2B shows RESTCONF Op ID which defines RESTCONF operations ID. Correlation module 230 does not invoke RESTCONF operations (which are invoked by RESTCONF server), but it does record the operations in the mapping table. For example, user 200 may add one tunnel or multiple tunnels in one operation. User 200 may also edit the tunnel to change the configuration, such as, change the number of the tunnels to be created.

The second column to the left of FIG. 2B shows the global operation status. Also, next to column 2, it shows the global operation error message. The control plane operation ID, namely, Job ID is assigned to individual operation. The control plane operational status indicates the different status for each control plane operation, which could be “OK”, “Error”, “In-progress”, or “none”.

The last column of FIG. 2B lists control plane 240 operational error messages and operates to report a possible reason for operational failure. By way of control plane error message examples, control plane 240 may report that the source port may not available, that there may not enough resources to increase bandwidth, or that the user specified tunnel path may not be available.

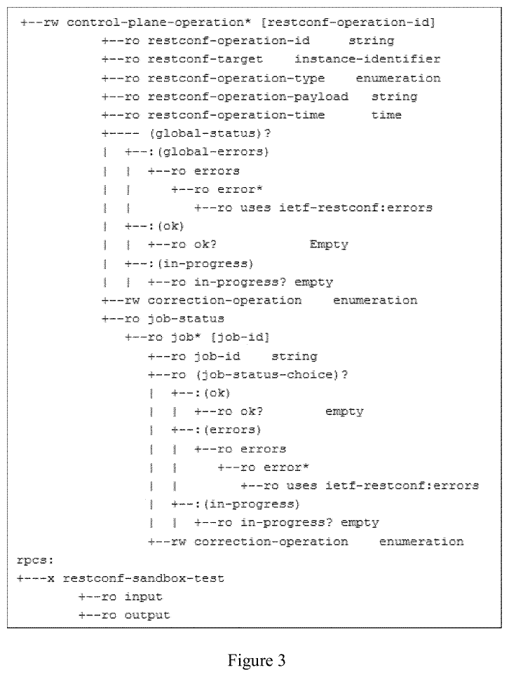

Control plane 240 invokes control plane operations to map each of the operations with the corresponding RESTCONF Jobs. From the ID to the status and the error message, control plane 240 correlates the RESTCONF operations and the control plane operations accordingly. Correlation module 230 may then write the mapping table into the YANG datastore's control plane operation data tree which will be explained below as shown in FIG. 3.

Correspondingly, correlation module 230 creates a control-plane job ID which associates it with the user configuration request having a RESTCONF operation ID. Correlation module 230 then invokes the control-plane operations, and associates those operations with control-plane job IDs. By doing so, correlation module 230 correlates the control-plane operations with the RESTCONF operations.

Control plane 240 may be configured to further verify the user configuration saved in intended configuration datastore 221 by the RESTCONF server. The configuration parameter may include relevant information, such as, for example, bandwidth of the tunnel, the source or destination Termination Point (TP), etc.

If control plane 240 succeeds in verifying the user configuration and implements the user configuration request, control plane 240 will write the applied user configuration into operational status datastore 222. If control plane 240 fails to implement the user configuration parameter, control plane 240 returns an error message to correlation module 230 to indicate the current operational status of control plane 240.

Correlation module 230 writes the error message in operational status datastore 222 under the control-plane-operation sub-tree whose schema is defined by the YANG model in FIG. 3. In this way, user 200 may query operational status datastore 222 to know the current status of the control plane operation.

In accordance with embodiments of the present disclosure, because correlation module 230 is configured to have RESTCONF interface (such as, for example, a YANG-based defined model), the correction relationship between the RESTCONF operations and the control plane operations may be displayed and communicated to user 200 via the RESTCONF interface. In view of this facility, control plane 240 may actively return error message to correlation module 230 and correlation module 230 may write and report the error into operational status datastore 222. As a result, user 200 may directly query operational status datastore 222 to determine whether the requested jobs are successfully performed or, if not, the reasons why requested jobs failed.

In turn, YANG datastore 220 responds to RESTCONF server 210 with the current status of control plane 240. As a result, server 210 returns a corresponding message to user 200. Therefore, user 200 may perform corresponding operations, such as, for example, manually operate his/her message to request a “retry”, “abort”, “stop”, “resume”, etc. operation.

For example, in some instances the bandwidth may be available later, so that user 200 may request a “retry” operation to make the request again. In other cases, if user 200 does not want to continue to further operations, he/she may select “abort” to cancel the operation.

By way of an illustrative example regarding the operations between the RESTCONF protocol and the control plane, if user 200 wants to create two “tunnels” within the network, i.e., Job 1 and Job 2, user 200 sends a request to the network indicating the configuration for the two jobs. As described above, RESTCONF server 210 checks the syntax and schematics of network configuration parameters of the request against the YANG model schema. Server 210 may store the configuration parameter into intended configuration datastore 221 and if the syntax and schematics of the request are determined to be acceptable, then control plane 240 may be invoked to configure the network configuration of the two requested two tunnels to the network hardware.

However, in the event that the complete user request may not be successfully implemented, such as, for example, the bandwidth of the network is not enough to perform the two jobs, source or destination TPs are already in use, etc., and that only Job 1 can be created, but the Job 2 fails. In such a case, control plane 240 may write the applied user configuration parameter of Job 1 to operational status datastore 222. As such, control plane 240 will return an error message to correlation module 230 to indicate the failure of Job 2 and correlation module 230 will write the error message into the YANG operational status datastore 222.

In so doing, if the current status stored in operational status datastore 222 indicates that the Job 2 has not been implemented due to the shortage of the bandwidth, user 200 may directly recall the current status of the control plane by querying the status data from operational status datastore 222. For example, the user may use RESTCONF “get” or “retrieve” message operations to query operational status datastore 222 to determine whether the requested jobs are successfully performed.

FIG. 3 depicts a non-limiting example of executable instructions regarding YANG-based constructs to perform operations, in accordance with embodiments of the present disclosure. As shown in FIG. 3, a global unique ID [restconf-operation-id] may be assigned to track RESTCONF operations. For example, if the operation is YANG-PATCH, then the ID is the same as PATCH-ID, which is generated by YANG-PATCH. However, if it is other RFC (Request for Comments) 8040 operation, the correlation module may generate an ID for it.

For the input information, for example, there are four elements as follow:

“restconf-target”,

“restconf-operation-type”,

“restconf-operation-payload” and

“restconf-operation-time”.

The “restconf-target” indicates where the user configuration should be stored in intended configuration datastore. The “restconf-operation-type” means the type of the RESTCONF operation, for example, “PUT”, “ADD”, etc. The “restconf-operation-payload” is in a format of a string attribute indicating the job to be done. For example, it shows the configurations of two “tunnels” that should be created as requested by the user. The RESTCONF payloads are recorded for debugging. A job ID “[job-id]” is assigned uniquely within one RESTCONF operation.

If the operation is YANG-PATCH, the id is the same as “edit-id” generated by YANG-PATCH. If it is another RFC 8040 operation, the job-status sub-tree may be empty, since the global-status is used. Finally, a “corrective operation” may be performed. Based on the error report, user 200 may further operate the job, for example, retry, abort, stop, resume, etc.

Therefore, owing to this embodiment, user 200 is capable of acquiring actual, updated operational status and error reports regarding network element configurations from control plane 240. Such updated status and reports provides user 200 with the information necessary to pursue further network maintenance actions.

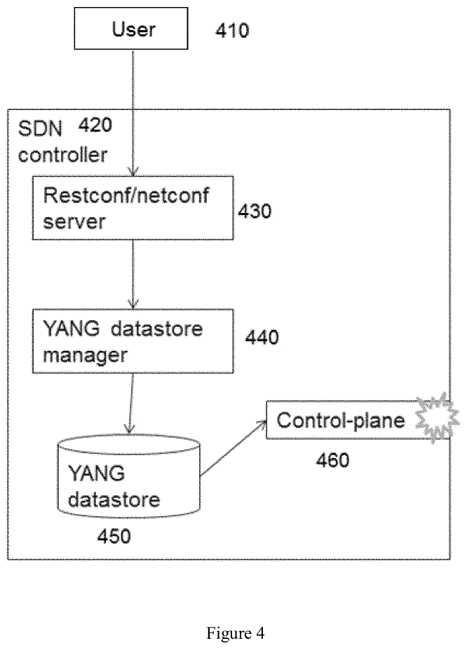

The configuration changes included in the request of user 200 may be syntactically and schematically valid relative to a RESTCONF operation. However, in the application's runtime context, it may be invalid. That is, as shown in FIG. 4, a flow diagram of a communication procedure between a user 410 and a SDN controller 420 or a network device in the prior art is illustrated. It is assumed that SDN controller 420 supports YANG models and manages its YANG datastore 450. User 410 may configure by sending configuration data requests via RESTCONF or NETCONF protocol. When SDN controller 420 receives the requested configuration data, datastore manager 440 performs syntax and mode schema checks on the configuration data to ensure the data is valid. It will be appreciated that, although the configuration data may be validated by YANG datastore 450, it may not be validated from the perspective of control plane 460.

The following described below attempts to address the problem mentioned above. In another embodiment of the present disclosure, a mechanism (i.e., software-based “sandbox” module) that provides a testing environment within the YANG model and generates the sandbox testing RESTCONF API (Application Program Interfaces) for simulated RESTCONF operations in the control plane is provided. The communication established between the user and the control plane is performed by means of RPC mechanism instead of using the RESTCONF operation. The RPC operation is an operation that may be invoked by a user on a server.

The sandbox module functions substantially the same as the correlation module in the previous embodiment. However, the user configuration will not be recorded or written into the datastore. Further, the sandbox module adds a flag to the existing control plane API to indicate that the operation is for validation purposes only. The user configuration will not be applied to the network hardware.

In this embodiment, it is noted that the user configuration is not stored in the intended configuration datastore. The control plane only validates the user configuration with the corresponding configuration requirement in the control plane in a simulation scenario. Actually, the user configuration is not applied to the network hardware in this embodiment so that the network hardware is not affected. Other than that, this embodiment does not require much change in the control plane, because it already has validation logic.

On the user side, RESTCONF RPCs are defined by the sandbox YANG model. The RPC input parameters contains the RESTCONF operations which are to be sandbox-validated, such as:

Operation=PUT,
URI=/tunnels/tunnel=xyz,
Payload=
{

“tunnel”: {

“src_node”: “a”,
“src_tp”: 1,
“dst_node”: “b”,
“dst_tp”: 20

}

}

In turn, the sandbox testing module processes and executes the RPC, such as:
(1) reads the RPC input parameters and the datastore content;
(2) generates the same input objects for the control plane as that generated by a regular RESTCONF operation; and
(3) calls the same control plane API as that invoked by a regular RESTCONF call flow, while also setting the sandbox flag to true.

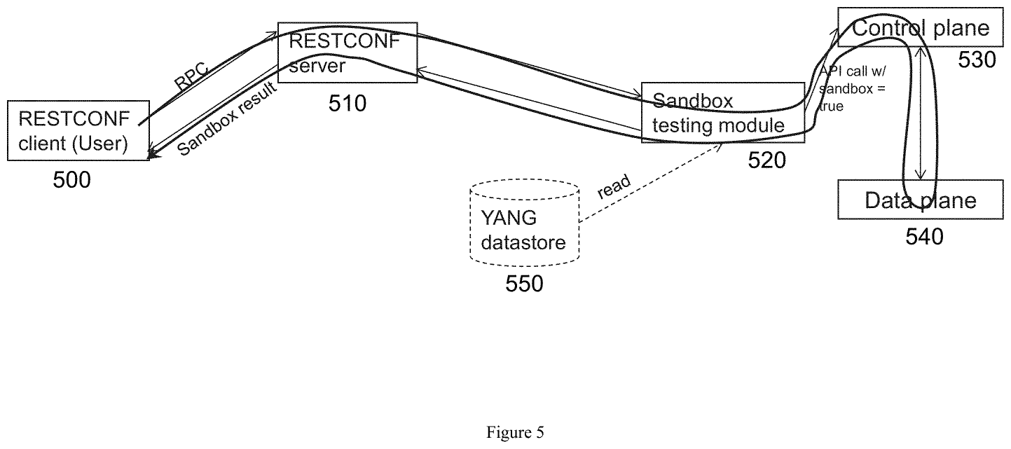

In the embodiment of the present disclosure, the RPC mechanism is used to establish the communication between the user and the control plane. As shown in FIG. 5, RESTCONF user 500 sends a request by use of RESTCONF RPC defined by the sandbox YANG model. RESTCONF server 510 verifies the user configuration requested in the input parameter. Sandbox testing module 520 operates as the same as correlation module 230 does. Other than that, sandbox testing module 520 also sends a flag to control plane 530.

The flag is a Boolean. It represents the application of the sandbox testing module. When its value is true, control plane 530 only performs the sematic validation and returns the result. Control plane 530, however, does not apply the user configuration to the network hardware. When the value is false, control plane 530 performs the normal operation. The default value is false.

In some cases, control plane 530 may check the validation of the configuration with data plane 540 by querying the API operations of data plane 540. If it is valid, control plane 530 sends back a successful message to sandbox testing module 520. In the end, server 510 sends the sandbox result back to user 500.

The function of sandbox testing module 520 just asks control plane 530 to verify the use configuration to see whether the user request can be fulfilled in the perspective of network hardware without applying the user configuration to the network hardware. For example, control plane 530 may check if the resource is available in the hardware in order to perform the user request. In this case, no hardware configuration is altered.

Optionally, according to the user request, in order to make sure the current configuration in the control plane is suitable for the operation of the request, sandbox testing module 520 may occasionally and optionally query YANG datastore 550 as shown by dashed line in FIG. 5 to make sure the availabilities and capabilities of control plane 530.

The above embodiment is intended to be illustrative only. In this embodiment, it is noted that YANG datastore 550 is optional. In certain embodiments, the above operations may be performed without YANG datastore.

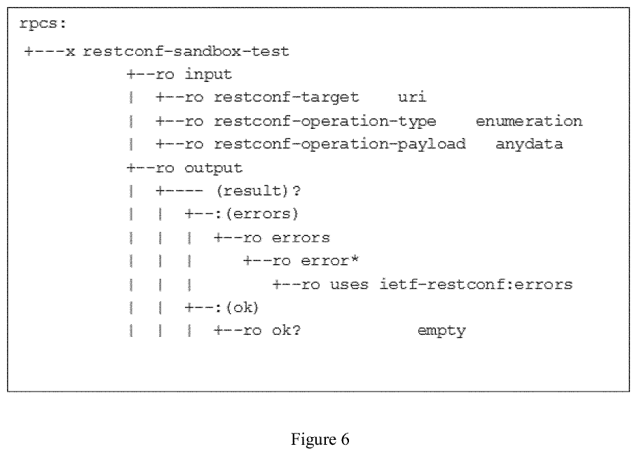

FIG. 6 depicts a schematic view of RESTCONF RPC mechanism implemented in the YANG model in accordance with the embodiment of the present disclosure. There are three elements as input parameters which simulate the RESTCONF operations as follow.

“restconf-target”;

“restconf-operation-type”; and

“restconf-operation-payload”.

The RESTCONF target means a destination to save the user's configuration. Here, the target is assigned as a Universal Resource Indicator (URI). For the type of operation, it may include POST, PUT, DELETE, PATCH, YANG-PATCH and etc. The RESTCONF payload includes the configuration of the job indicated in the user request. In this embodiment, the payload is used for validation of the user configuration.

For example, null means DELETE. The control plane validates the user's configuration with the hardware resources and settings. If the validation fails, the control plane may provide an error message, which may be captured in the line “ietf-restconf: errors”.

The present disclosure has been described in the foregoing specification by means of non-restrictive illustrative embodiments provided as examples. These illustrative embodiments may be modified at will. The scope of the claims should not be limited by the embodiments set forth in the examples, but should be given the broadest interpretation consistent with the description as a whole.

1. A method of providing improved status reporting communications between management plane and control plane operations in a software-defined networking (SDN) communication system, the method comprising:
receiving, at a server, a user configuration request to establish a connection with the server and to implement a configuration change of a network element;
assigning an operational ID to the user configuration request in a mapping table identifying operational parameters interacting between the management plane and the control plane;
validating the user configuration request in accordance with a configuration datastore;
assigning a control plane job ID to the user configuration request in the mapping table;
correlating the assigned operational ID with the assigned control plane job ID in the mapping table;
requesting the control plane to verify the implementation of the user configuration request based on the corresponding control plane operation; and
upon receiving verification from the control plane that:
the user configuration request has been implemented, writing into an operational status datastore a record of the implemented user configuration request,
the user configuration request has not been implemented returning an error status message and storing the error status message in the operational status datastore associated with the management plane.

2. The method of claim 1, wherein validating the user configuration request including validating syntax and schematics with Yet Another Next Generation (YANG) model schema.

3. The method of claim 1, wherein verifying the user configuration request including performing data schema check with the operational status datastore.

4. The method of claim 1, further comprising querying the current operational status of the control plane to the operational status datastore.

5. The method of claim 4, further comprising performing corresponding operations based on the current operational status of the control plane.

6. The method of claim 5, wherein performing the operations including retrying, aborting, cancelling and resuming the operations of the user request.

7. The method of claim 1, wherein the operation is either YANG-PATCH operation or RFC 8040 operation.

8. The method of claim 1, further comprising applying the user configuration to the network element.

9. An architecture for providing improved reporting status communications between a management plane and control plane operations in a software-defined networking (SDN) communication system, comprising:
a server configured to receive a user configuration request to establish a connection with the server and to implement a configuration change of a network element, the server further configured to validate the user configuration request;
a network protocol datastore including an intended configuration datastore and an operational status datastore, configured to store a user configuration and associated operational status;
a control plane configured to verify the user configuration request; and
a correlation module configured to provide a network interface to correlate the control plane operations with the management plane operations by implementing a mapping table identifying operational parameters interacting between the management plane and the control plane and configured to:
assign an operation ID to the user configuration request in the mapping table;
assign a control plane job ID to the user configuration request in the mapping table;
wherein upon the control plane has implemented the user configuration request, the control plane writes into the operational status datastore a record of the implemented user configuration request, and upon the control plane has not implemented the user configuration request, the control plane returns an error status message to the correlation module, and the correlation module stores the error status message into the operational status datastore associated with the management plane.

10. The architecture of claim 9, wherein the correlation module is further configured to:
correlate the assigned operation ID with the assigned control plane job ID in the mapping table; and
request the control plane to verify the user configuration request based on the corresponding control plane operation.

11. The architecture of claim 9, wherein the server is further configured to validate syntax and schematics with YANG model schema.

12. The architecture of claim 9, wherein the control plane is further configured to perform data schema check to verify the user configuration request with the operational status datastore.

13. The architecture of claim 9, wherein the current operational status of the control plane is queried from the operational status datastore.

14. The architecture of claim 13, wherein corresponding operations are performed based on the current operational status of the control plane.

15. The architecture of claim 14, wherein the corresponding operations include retry, abort, cancel and resume the user configuration request.

16. The architecture of claim 9, wherein the operation is either YANG-PATCH operation or RFC 8040 operation.

17. The architecture of claim 9, wherein the user configuration is applied to the hardware of the network element.
